(19) United States
(12) Patent Application Publication
(10) Pub. No.: US 2016/0238164 A1
(43) Pub. Date: Aug. 18, 2016

(54) ACRYLIC RUBBER COMPOSITION FOR HEAT-RESISTANT HOSE AND HEAT-RESISTANT HOSE USING THE SAME

(71) Applicant: SUMITOMO RIKO COMPANY LIMITED, Komaki-shi (JP)

(72) Inventors: Hiroaki Sakaue, Kasugai-shi (JP); Masashi Noda, Kitanagoya-shi (JP); Motoki Hirado, Kasugai-shi (JP)

(73) Assignee: SUMITOMO RIKO COMPANY LIMITED, Komaki-shi (JP)

(21) Appl. No.: 14/990,083

(22) Filed: Jan. 7, 2016

(30) Foreign Application Priority Data
Feb. 18, 2015 (JP) 2015-029528

(51) Int. Cl. F16L 11/08; C08L 13/00

(52) U.S. Cl. CPC F16L 11/08; C08L 13/00; C08L 2312/00; C08L 2201/08

(57) ABSTRACT

Provided are an acrylic rubber composition for a heat-resistant hose having high electric resistance and high strength and being excellent in suppression of the generation of bubble marks at the time of the production of a hose and a heat-resistant hose using the acrylic rubber composition for a heat-resistant hose. An innermost layer of the heat-resistant hose is formed by using an acrylic rubber composition for a heat-resistant hose, containing the following components (A) to (C) and having a content ratio between the component (A) and the component (B), (A)/(B), of from 95/5 to 45/55 in terms of a weight ratio: (A) an ethylene-acrylic rubber (AEM); (B) an acrylic rubber (ACM) excluding the component (A); and (C) carbon black having a value of iodine adsorption amount (mg/g)×DBP absorption amount (cm³/100 g) of from 1,500 to 7,200.

### BACKGROUND

1. Field of the Invention

The present invention relates to an acrylic rubber composition for a heat-resistant hose and a heat-resistant hose using the acrylic rubber composition for a heat-resistant hose, and a method of producing a heat-resistant hose, and more specifically, to an acrylic rubber composition for a heat-resistant hose to be used as a material for an oil system hose, such as an oil cooler hose for an automatic transmission in a transport vehicle including an automobile, or for an air system hose, such as a turbo air hose, and a heat-resistant hose using the acrylic rubber composition for a heat-resistant hose, and a method of producing a heat-resistant hose.

2. Description of the Related Art

Hitherto, an acrylic rubber excellent in heat resistance has been mainly used as a material for forming a heat-resistant hose, such as an oil cooler hose for an automatic transmission (AT or CVT) for an automobile or a turbo air hose for an automobile (see Japanese Patent No. 3587221, Japanese Patent No. 5252774, and Japanese Patent Application Laid-open No. 2012-207748).

The hose as described above is generally mounted to each device in an engine compartment by inserting a substantially tubular hose ferrule provided on each device into an end opening of the hose.

In this case, it is known that when the conductivity of an innermost layer of the hose is high, the rupture of the hose, the occurrence of metal corrosion at an interface between the innermost layer of the hose and the hose ferrule, and the like may be caused by static electricity generated by running of an automobile, static electricity generated by a fluid flowing through the hose, or the passage of an electric current caused by leakage of electricity from a storage battery.

Under such circumstances, it is known that, in a heat-resistant hose for the applications as described above, it is effective to impart high electrical resistivity to a material for the innermost layer of the hose for the purpose of preventing the passage of an electric current, in order to prevent the rupture of the hose and the occurrence of metal corrosion. Thus, carbon black having high electric resistance is used as a filler (reinforcing material) in the material for the innermost layer of the hose.

Further, as a polymer of the material for the innermost layer of the hose, an ethylene-acrylic rubber (AEM) is desirably used by virtue of its high strength.

However, carbon black having high electric resistance, that is, carbon black having a large surface area has a weak reinforcing property for a rubber composition and also has an action of decreasing the viscosity of the rubber composition. Further, the above-mentioned AEM has a low viscosity. For those reasons, when an innermost layer of a hose is formed of an acrylic rubber composition having high electric resistance in which carbon black having high electric resistance is blended with an AEM polymer, there is a problem in that uneven bubble marks (pockmarks) may be generated on an inner peripheral surface of the hose. That is, water and a release agent accumulated between a mandrel to be used in producing the hose and the innermost layer of the hose are evaporated, and the elastic force of the rubber is defeated by the force caused by the evaporation of the water and the release agent, with the result that the bubble marks as described above are generated.

### SUMMARY

An acrylic rubber composition for a heat-resistant hose having high electric resistance and high strength and being excellent in suppression of the generation of bubble marks at the time of the production of a hose and a heat-resistant hose using the acrylic rubber composition for a heat-resistant hose, and a method of producing a heat-resistant hose are provided.

A first aspect resides in an acrylic rubber composition for a heat-resistant hose, containing the following components (A) to (C) and having a content ratio between the component (A) and the component (B), (A)/(B), of from 95/5 to 45/55 in terms of a weight ratio:

(A) an ethylene-acrylic rubber (AEM);

(B) an acrylic rubber (ACM) excluding the component (A); and

(C) carbon black having a value of iodine adsorption amount (mg/g)×DBP absorption amount (cm³/100 g) of from 1,500 to 7,200.

In addition, a second aspect resides in a heat-resistant hose, including at least one structural layer, in which the at least one structural layer includes an innermost layer including an acrylic rubber composition such as the acrylic rubber composition of the first aspect.

In addition, a third aspect resides in a method of producing a heat-resistant hose, the method including: extruding an acrylic rubber composition such as the acrylic rubber composition of the first aspect onto a mandrel into a hose shape; vulcanizing the extruded unvulcanized rubber hose with pressurized steam; and pulling out the vulcanized rubber hose from the mandrel.

Specifically, to solve the above-mentioned problems, as the rubber composition for forming the innermost layer of the hose, a rubber composition can contain a polymer having blended therein an ethylene-acrylic rubber (AEM) excellent in strength, heat resistance, and the like and an acrylic rubber (ACM) in a particular ratio, in which carbon black having a value of iodine adsorption amount (mg/g)×DBP absorption amount (cm³/100 g) of from 1,500 to 7,200 is blended with the polymer. As a result, the above-mentioned problem of a decrease in viscosity caused by carbon black and AEM can be solved, and further the water-absorbing property of ACM is satisfactorily expressed by virtue of the blending at a particular ratio, which can weaken the evaporation force of water accumulated between the mandrel and the innermost layer of the hose to suppress the generation of bubble marks, to thereby arrive at the present invention.

As described above, the acrylic rubber composition for a heat-resistant hose contains AEM and ACM at a particular ratio, and contains particular carbon black as a filler therefor. Therefore, the acrylic rubber composition for a heat-resistant hose has high electric resistance and high strength and is excellent in suppression of the generation of bubble marks at the time of the production of the hose through use of the mandrel. Because of those characteristics, the acrylic rubber composition for a heat-resistant hose can exhibit excellent performance as a material for an innermost layer of an oil system hose, such as an oil cooler hose for an automatic transmission (AT or CVT) in a transport vehicle including an automobile, or an air system hose, such as a turbo air hose.

### DETAILED DESCRIPTION OF PARTICULAR EMBODIMENTS

Next, embodiments of the present invention are described in detail.

An acrylic rubber composition for a heat-resistant hose contains the following components (A) to (C) and has a content ratio between the component (A) and the component (B), (A)/(B), of from 95/5 to 45/55 in terms of a weight ratio. Further, there is no particular limitation on a heat-resistant hose regarding whether the heat-resistant hose has a single-layer structure or a multi-layer structure including two or more laminated layers. However, at least an innermost layer thereof (in the case where the heat-resistant hose has the single-layer structure, the single layer) is formed of the acrylic rubber composition.

(A) An ethylene-acrylic rubber (AEM)

(B) An acrylic rubber (ACM) excluding the component (A)

(C) Carbon black having a value of iodine adsorption amount (mg/g)×DBP absorption amount (cm³/100 g) of from 1,500 to 7,200

<<Ethylene-Acrylic Rubber (Component (A)) and Acrylic Rubber (Component (B))>>

The ethylene-acrylic rubber (AEM) as the component (A) contains, as a main component, one kind or two or more kinds of (meth)acrylic monomers and has introduced therein an ethylene monomer. Further, the acrylic rubber (ACM) as the component (B) excludes the component (A). Therefore, the acrylic rubber (ACM) as the component (B) contains, as a main component, one kind or two or more kinds of (meth)acrylic monomers, and does not have introduced therein an ethylene monomer or has introduced therein the ethylene monomer to such an extent that characteristics are not affected (that is, introduced in an amount of less than 5 wt %). It should be noted that the (meth)acrylic monomer as used herein means an acrylic monomer or a methacrylic monomer.

Examples of the acrylic monomer include acrylates, such as methyl acrylate, ethyl acrylate, propyl acrylate, n-butyl acrylate, n-octyl acrylate, methoxymethyl acrylate, methoxyethyl acrylate, and ethoxyethyl acrylate. Further, examples of the methacrylic monomer include methacrylates corresponding to the acrylic monomers.

Further, the ethylene-acrylic rubber (component (A)) and the acrylic rubber (component (B)) each have the above-mentioned monomer composition and are each copolymerized with a crosslinking monomer by a known method, such as emulsion polymerization, suspension polymerization, solution polymerization, or bulk polymerization. The kind and molar ratio of the crosslinking monomer are not limited. Examples of the crosslinking monomer include: active chlorine-based monomers, such as 2-chloroethyl vinyl ether and vinyl chloroacetate; carboxyl-based monomers, such as butanedioic acid monoalkyl esters, specifically a maleic acid monoalkyl ester, a fumaric acid monoalkyl ester, and an itaconic acid monoalkyl ester; and epoxy-based monomers, such as glycidyl acrylate, glycidyl methacrylate, allyl glycidyl ether, and methallyl glycidyl ether. The crosslinking monomer may be subjected to the copolymerization at such a molar ratio that the content of the crosslinking monomer becomes from 0.5 wt % to 2 wt %.

In addition, in the acrylic rubber composition for a heat-resistant hose, the content ratio between the ethylene-acrylic rubber (component (A)) and the acrylic rubber (component (B)), [(A)/(B)], falls within a range of from 95/5 to 45/55, preferably from 93/7 to 70/30 in terms of a weight ratio. That is, the reason for this is as follows: when the ratio of the ethylene-acrylic rubber is too small (the ratio of the acrylic rubber is too large), foaming may occur in a layer of a hose owing to excessive water absorption; and when the ratio of the ethylene-acrylic rubber is too large (the ratio of the acrylic rubber is too small), uneven bubble marks (pockmarks) may be generated on an inner peripheral surface of the hose at the time of the production of the hose through use of a mandrel.

<<Carbon Black (Component (C))>>

As carbon black to be used in the acrylic rubber composition for a heat-resistant hose, carbon black having a value of iodine adsorption amount (mg/g)×DBP absorption amount (cm³/100 g) of from 1,500 to 7,200 is used. Carbon black having a value of iodine adsorption amount (mg/g)×DBP absorption amount (cm³/100 g) of from 1,700 to 4,000 is preferably used. That is, the reason for this is as follows: when the value of iodine adsorption amount×DBP absorption amount is too large, desired high electric resistivity may not be obtained, and there is a risk in that the hose may be ruptured or rust may occur on a hose ferrule; and in contrast, when the value of iodine adsorption amount×DBP absorption amount is too small, uneven bubble marks (pockmarks) are generated on the inner peripheral surface of the hose, and thus molding processability of a rubber layer becomes degraded.

It should be noted that the iodine adsorption amount of carbon black is measured in conformity to JIS K 6217-1 (A method). Specifically, first, 0.5000 g±0.0005 g of dried carbon powder is correctly weighed in a 200-ml or 250-ml stoppered conical flask, and 25 ml of a 0.0473 N iodine solution is added thereto. The conical flask is vigorously shaken for at least 30 seconds at room temperature at a rate of 120 times or more per minute. Immediately after the shaking, the carbon powder is separated by any of a still standing method, a filtration method, and a centrifugation method. Then, 20 ml of the filtrate or the supernatant is taken and titrated with a 0.0394 N sodium thiosulfate solution (this titer is defined as a ml). Meanwhile, a blank test is conducted separately by the same operation as the foregoing, and the titer in this case is defined as b ml. Then, the iodine adsorption amount with respect to 1 g of the carbon powder is calculated by the expression (1) below.

IA=[(b−a)/b]×(V/W)×N×126.91×f (1)

In the expression (1),

IA represents the iodine adsorption amount (mg/g),
W represents the mass (g) of the dried carbon powder,
V represents the amount of the iodine solution initially added,
N represents the standard normal concentration (0.0473) of the iodine solution, and
f represents a factor of the iodine solution.

In addition, the iodine adsorption amount falls within a range of preferably from 20 mg/g to 40 mg/g, more preferably from 20 mg/g to 30 mg/g.

Further, the dibutyl phthalate (DBP) absorption amount of carbon black is a value measured by JIS K 6217-4. The DBP absorption amount falls within a range of preferably from 60 cm³/100 g to 160 cm³/100 g, more preferably from 80 cm³/100 g to 130 cm³/100 g.

The above-mentioned particular carbon black (component (C)) needs to satisfy the definition of the iodine adsorption amount×DBP absorption amount as described above. Examples of such carbon black include MAF-grade carbon black, FEF-grade carbon black, GPF-grade carbon black, SRF-grade carbon black, and SRF-HS-FY-grade carbon black.

The content of the particular carbon black (component (C)) is preferably from 40 parts by weight to 90 parts by weight, particularly preferably from 50 parts by weight to 80 parts by weight with respect to 100 parts by weight of the total content of the ethylene-acrylic rubber (component (A)) and the acrylic rubber (component (B)) which serve as a polymer component. When the acrylic rubber composition for a heat-resistant hose contains the particular carbon black (component (C)) in such amount, a desired reinforcing property and the like can be obtained.

It should be noted that a vulcanizing agent, a vulcanizing aid, a processing aid, a plasticizer, an age resistor, a flame retardant, and the like are appropriately blended in the acrylic rubber composition for a heat-resistant hose, in addition to the ethylene-acrylic rubber (component (A)), the acrylic rubber (component (B)), and the particular carbon black (component (C)). Further, in the case where the acrylic rubber composition for a heat-resistant hose is crosslinked with an organic peroxide, a co-crosslinking agent may be used together so as to enhance crosslinking efficiency and improve physical properties.

Examples of the vulcanizing agent include imidazole compounds, such as 1-methylimidazole, 1,2-dimethylimidazole, 1-benzyl-2-methylimidazole, and 1-cyanoethyl-2-methylimidazole, hexamethylenediamine, hexamethylenediamine carbamate, tetramethylenepentamine, a hexamethylenediamine-cinnamaldehyde adduct, ammonium benzoate, hexamethylenediamine dibenzoate salt, 4,4′-methylenedianiline, 4,4′-oxyphenyldiphenylamine, m-phenylenediamine, p-phenylenediamine, and 4,4′-methylenebis(o-chloroaniline).

Examples of the vulcanizing aid include trimethylthiourea, stearyltrimethylammonium bromide, and di-o-tolylguanidine.

Examples of the processing aid include stearic acid, n-octadecylamine, and polyoxyethylene stearyl ether phosphate.

Examples of the plasticizer include adipate-based oil, polyether-based oil, and polyester-based oil.

An example of the age resistor is 4,4′-(α,α-dimethylbenzyl)diphenylamine.

Examples of the organic peroxide include: peroxyketals, such as 1,1-bis(t-butylperoxy)-3,3,5-trimethylcyclohexane, 1,1-bis(t-hexylperoxy)-3,3,5-trimethylcyclohexane, 1,1-bis(t-hexylperoxy)cyclohexane, 1,1-bis(t-butylperoxy)cyclododecane, 1,1-bis(t-butylperoxy)cyclohexane, 2,2-bis(t-butylperoxy)octane, n-butyl-4,4-bis(t-butylperoxy)butane, and n-butyl-4,4-bis(t-butylperoxy)valerate; dialkyl peroxides, such as di-t-butyl peroxide, dicumyl peroxide, t-butylcumyl peroxide, α,α′-bis(t-butylperoxy-m-isopropyl)benzene, α,α′-bis(t-butylperoxy)diisopropylbenzene, 2,5-dimethyl-2,5-di(t-butylperoxy)hexane, and 2,5-dimethyl-2,5-bis(t-butylperoxy)hexyne-3; diacyl peroxides, such as acetyl peroxide, isobutyryl peroxide, octanoyl peroxide, decanoyl peroxide, lauroyl peroxide, 3,5,5-trimethylhexanoyl peroxide, benzoyl peroxide, 2,4-dichlorobenzoyl peroxide, and m-toluoyl peroxide; peroxyesters, such as t-butyl peroxyacetate, t-butyl peroxyisobutyrate, t-butyl peroxy-2-ethylhexanoate, t-butyl peroxylaurate, t-butyl peroxybenzoate, di-t-butyl peroxyisophthalate, 2,5-dimethyl-2,5-di(benzoylperoxy)hexane, t-butylperoxymaleic acid, t-butyl peroxyisopropylcarbonate, and cumyl peroxyoctate; and hydroperoxides, such as t-butyl hydroperoxide, cumene hydroperoxide, diisopropylbenzene hydroperoxide, 2,5-dimethylhexane-2,5-dihydroperoxide, and 1,1,3,3-tetramethylbutyl peroxide.

Examples of the co-crosslinking agent include a sulfur-containing compound, a polyfunctional monomer, a maleimide compound, and a quinone compound.

Examples of the sulfur-containing compound include sulfur, dipentamethylenethiuram tetrasulfide, and mercaptobenzothiazole. Examples of the polyfunctional monomer include divinylbenzene, ethylene glycol dimethacrylate, diallyl phthalate, trimethylolpropane trimethacrylate, triallyl cyanurate, triallyl isocyanurate (TRIC), triallyl trimellitate, and triallyl tricyanurate. Further, examples of the maleimide compound include N,N′-m-phenylenebismaleimide and toluylenebismaleimide. Examples of the quinone compound include quinone dioxime and dibenzoyl-p-quinone dioxime.

The heat-resistant hose may be produced, for example, as follows. That is, first, the ethylene-acrylic rubber (component (A)), the acrylic rubber (component (B)), and the particular carbon black (component (C)) are blended, and further a vulcanizing agent, a vulcanizing aid, a processing aid, a plasticizer, an age resistor, and the like are appropriately blended. Then, the resultant is kneaded with a kneading device, such as a roll, a kneader, or a Banbury mixer, to thereby prepare the acrylic rubber composition (acrylic rubber composition for a heat-resistant hose). Next, the acrylic rubber composition is extruded into a tubular shape (cylindrical shape) to form an unvulcanized rubber layer. It should be noted that, in the case where the heat-resistant hose is formed into a multi-layer structure, layers formed of various rubbers and resins are formed on an outer periphery of the rubber layer (innermost layer) by extrusion or the like. Further, in the case where a splicing yarn layer is formed, a splicing yarn is subjected to braid knitting or the like at a predetermined number of yarns and a predetermined number of ends and picks, to thereby form the splicing yarn layer on the outer periphery of the rubber layer (innermost layer). A mandrel is inserted into a hose structure in an unvulcanized state thus obtained. It should be noted that a release agent, such as a silicone oil-based release agent, may be applied onto the surface of the mandrel, as necessary. Alternatively, the acrylic rubber composition may be directly extruded onto the mandrel instead of inserting the mandrel into the hose structure in an unvulcanized state (unvulcanized rubber hose) as described above. Then, the unvulcanized rubber hose extruded onto the mandrel as described above is vulcanized with pressurized steam. After that, the mandrel is pulled out, and the resultant is subjected to secondary vulcanization in an oven as necessary. Thus, an intended heat-resistant hose can be produced.

There is no particular limitation on the heat-resistant hose thus obtained regarding whether the heat-resistant hose has a single-layer structure or a multi-layer structure including two or more laminated layers. However, at least an innermost layer thereof (in the case where the heat-resistant hose has the single-layer structure, the single layer) is formed of the acrylic rubber composition. Therefore, the heat-resistant hose is excellent in product properties because the heat-resistant hose has high electric resistance and high strength and no bubble marks are found on an inner peripheral surface of the innermost layer or in the innermost layer.

In the heat-resistant hose, the innermost layer (in the case where the heat-resistant hose has the single-layer structure, the single layer) has a thickness of preferably from 0.25 mm to 20 mm, particularly preferably from 0.5 mm to 10 mm. Further, the heat-resistant hose has an inner diameter of preferably from 2 mm to 100 mm, particularly preferably from 5 mm to 70 mm.

The heat-resistant hose can be used for general hoses required to have heat resistance, but is preferably used as heat-resistant hoses, in which their innermost layers are required to have high electric resistance, including an oil system hose, such as an oil cooler hose for an automatic transmission (AT or CVT) in a transport vehicle including an automobile, and an air system hose, such as a turbo air hose.

### EXAMPLES

Next, Examples are described together with Comparative Examples. It should be noted that the present invention is not limited to these Examples without departing from the aspect of the present invention.

First, the following materials were prepared prior to Examples and Comparative Examples. It should be noted that in “I₂×DBP” shown in carbon black (CB-1 to CB-8) below, “I₂” represents an iodine adsorption amount (mg/g) of carbon black, which is a value measured in conformity to JIS K 6217-1 (A method), “DBP” represents a DBP absorption amount (cm³/100 g) of carbon black, which is a value measured in conformity to JIS K 6217-4, and “I₂×DBP” is a product of those values.

[AEM]

VAMAC G, manufactured by DuPont

[ACM]

NOXTITE PA522, manufactured by NOK Corporation

[Stearic Acid]

LUNAC S-30, manufactured by Kao Corporation

[Age Resistor]

NAUGARD 445, manufactured by Chemtura Corporation

[Amine Vulcanizing Agent]

DIAK #1, manufactured by DuPont

[Vulcanization Accelerator]

SOXINOL DT, manufactured by Sumitomo Chemical Company, Limited

[Carbon Black (CB-1)]

ISAF-grade carbon black (I₂×DBP=13,794) (SEAST 6, manufactured by Tokai Carbon Co., Ltd.)

[Carbon Black (CB-2)]

HAF-grade carbon black (I₂×DBP=8,080) (SEAST 3, manufactured by Tokai Carbon Co., Ltd.)

[Carbon Black (CB-3)]

MAF-grade carbon black (I₂×DBP=7,049) (SEAST 116, manufactured by Tokai Carbon Co., Ltd.)

[Carbon Black (CB-4)]

FEF-grade carbon black (I₂×DBP=5,060) (SEAST SO, manufactured by Tokai Carbon Co., Ltd.)

[Carbon Black (CB-5)]

GPF-grade carbon black (I₂×DBP=2,262) (SEAST V, manufactured by Tokai Carbon Co., Ltd.)

[Carbon Black (CB-6)]

SRF-HS-FY-grade carbon black (I₂×DBP=3,648) (SEAST FY, manufactured by Tokai Carbon Co., Ltd.)

[Carbon Black (CB-7)]

SRF-grade carbon black (I₂×DBP=1,768) (SEAST S, manufactured by Tokai Carbon Co., Ltd.)

[Carbon Black (CB-8)]

FT/MT-grade carbon black (I₂×DBP=756) (SEAST TA, manufactured by Tokai Carbon Co., Ltd.)

[Plasticizer]

BXA-R, manufactured by Daihachi Chemical Industry Co., Ltd.

[Organic Peroxide]

PERBUTYL P, manufactured by NOF Corporation

[Co-Crosslinking Agent]

TRIC, manufactured by Nippon Kasei Chemical Company Limited

### Examples 1 to 10 and Comparative Examples 1 to 6

Each of the above-mentioned components was blended in a ratio shown in Table 1 and Table 2 described later and kneaded with a 5 L kneader, to thereby prepare an acrylic rubber composition.

The rubber compositions of Examples and Comparative Examples thus obtained were each extruded into a tubular shape (cylindrical shape) having an inner diameter of 45 mm and a thickness of 5 mm and then cut into a length of 100 mm. Then, a straight metal mandrel having an outer diameter of 45 mm having a silicone oil-based release agent applied thereonto was inserted into each of the extruded unvulcanized rubber hoses. The extruded unvulcanized rubber hoses were each vulcanized with steam at 160° C. for 60 minutes, and pulled out from the metal mandrel. Further, the resultant was subjected to secondary vulcanization in an oven at 150° C. for 8 hours to obtain a rubber hose. The resultant rubber hoses were evaluated for the respective characteristics in accordance with the following criteria. The results are shown in Table 1 and Table 2 below.

[ρν(Ω·cm)]

The surface of a sample having a rectangular parallelepiped shape obtained by cutting out any portion of the rubber hose was measured for a volume resistivity ρν (Ω·cm) by a double ring electrode method (JIS K6271).

[Pockmark]

The inner peripheral surface of the rubber hose was visually observed. As a result, the case where bubble marks (pockmarks) were not observed on the inner peripheral surface was evaluated as “o”, and the case where bubble marks (pockmarks) were observed on the inner peripheral surface was evaluated as X.

[Foaming]

The rubber hose was cut at any position, and the cut surface was visually observed. As a result, the case where air bubbles caused by foaming were not observed was evaluated as “∘”, and the case where air bubbles caused by foaming were observed was evaluated as “x”.

[Rust Test]

An aluminum pipe was inserted into the rubber hose, and salt water was sprayed onto the resultant for 168 hours by methods of salt spray testing (JIS Z2371). Thereafter, the case where red rust was not observed on the surface of the aluminum pipe brought into contact with the inner peripheral surface of the rubber hose was evaluated as “∘”, and the case where red rust was observed on the surface of the aluminum pipe brought into contact with the inner peripheral surface of the rubber hose was evaluated as “x”.

TABLE 1
(Parts by weight)

| | Example | | | | | | | | | |
|---|---|---|---|---|---|---|---|---|---|---|
| | 1 | 2 | 3 | 4 | 5 | 6 | 7 | 8 | 9 | 10 |
| AEM | 90 | 90 | 90 | 90 | 90 | 95 | 93 | 70 | 45 | 90 |
| ACM | 10 | 10 | 10 | 10 | 10 | 5 | 7 | 30 | 55 | 10 |
| Stearic acid | 2 | 2 | 2 | 2 | 2 | 2 | 2 | 2 | 2 | 2 |
| Age resistor | 2 | 2 | 2 | 2 | 2 | 2 | 2 | 2 | 2 | 2 |
| Amine | 2 | 2 | 2 | 2 | 2 | 2 | 2 | 2 | 2 | — |
| vulcanizing | | | | | | | | | | |
| agent | | | | | | | | | | |
| Vulcanization | 4 | 4 | 4 | 4 | 4 | 4 | 4 | 4 | 4 | — |
| accelerator | | | | | | | | | | |
| CB-1 | — | — | — | — | — | — | — | — | — | — |
| CB-2 | — | — | — | — | — | — | — | — | — | — |
| CB-3 | 60 | — | — | — | — | — | — | — | — | — |
| CB-4 | — | 60 | — | — | — | — | — | — | — | — |
| CB-5 | — | — | 60 | — | — | 60 | 60 | 60 | 60 | 60 |
| CB-6 | — | — | — | 60 | — | — | — | — | — | — |
| CB-7 | — | — | — | — | 60 | — | — | — | — | — |
| CB-8 | — | — | — | — | — | — | — | — | — | — |
| Plasticizer | 15 | 15 | 15 | 15 | 15 | 15 | 15 | 15 | 15 | 15 |
| Organic peroxide | — | — | — | — | — | — | — | — | — | 1.5 |
| Co-crosslinking | — | — | — | — | — | — | — | — | — | 1.5 |
| agent | | | | | | | | | | |
| ρv | 3.8 × 10⁴ | 1.8 × 10⁵ | 4.3 × 10⁶ | 1.3 × 10⁶ | 2.6 × 10⁷ | 4.1 × 10⁸ | 3.0 × 10⁶ | 5.5 × 10⁶ | 2.0 × 10⁶ | 1.1 × 10⁷ |
| (Ω · cm) | | | | | | | | | | |
| Pockmark | ∘ | ∘ | ∘ | ∘ | ∘ | ∘ | ∘ | ∘ | ∘ | ∘ |
| Foaming | ∘ | ∘ | ∘ | ∘ | ∘ | ∘ | ∘ | ∘ | ∘ | ∘ |
| Rust test | ∘ | ∘ | ∘ | ∘ | ∘ | ∘ | ∘ | ∘ | ∘ | ∘ |

TABLE 2
(Parts by weight)

| | Comparative Example | | | | | |
|---|---|---|---|---|---|---|
| | 1 | 2 | 3 | 4 | 5 | 6 |
| AEM | 100 | 97 | 35 | 90 | 90 | 90 |
| ACM | — | 3 | 65 | 10 | 10 | 10 |
| Stearic acid | 2 | 2 | 2 | 2 | 2 | 2 |
| Age resistor | 2 | 2 | 2 | 2 | 2 | 2 |
| Amine vulcanizing agent | 2 | 2 | 2 | 2 | 2 | 2 |
| Vulcanization accelerator | 4 | 4 | 4 | 4 | 4 | 4 |
| CB-1 | — | — | — | 60 | — | — |
| CB-2 | — | — | — | — | 60 | — |
| CB-3 | — | — | — | — | — | — |
| CB-4 | — | — | — | — | — | — |
| CB-5 | 60 | 60 | 60 | — | — | — |
| CB-6 | — | — | — | — | — | — |
| CB-7 | — | — | — | — | — | — |
| CB-8 | — | — | — | — | — | 60 |
| Plasticizer | 15 | 15 | 15 | 15 | 15 | 15 |
| Organic peroxide | — | — | — | — | — | — |
| Co-crosslinking agent | — | — | — | — | — | — |
| ρv | 1.41 × 10⁹ | 3.82 × 10⁸ | 3.19 × 10⁶ | 8.01 × 10² | 1.66 × 10³ | 1.51 × 10⁹ |
| (Ω · cm) | | | | | | |
| Pockmark | x | x | ∘ | ∘ | ∘ | x |
| Foaming | ∘ | ∘ | x | ∘ | ∘ | ∘ |
| Rust test | ∘ | ∘ | ∘ | x | x | ∘ |

According to the above-mentioned results, each hose of Examples had high electric resistance, in which rust was not observed on a hose ferrule, and none of pockmarks on the inner peripheral surface and foaming in the hose layer was observed.

In contrast, the hose of Comparative Example 1 did not contain ACM in its material (acrylic rubber composition), and the generation of pockmarks on the inner peripheral surface was observed. The hose of Comparative Example 2 contained ACM in its material (acrylic rubber composition), but the ratio of ACM was too small, with the result that the generation of pockmarks on the inner peripheral surface was also observed. In the hose of Comparative Example 3, the ratio of ACM in its material (acrylic rubber composition) was too large, with the result that foaming in the hose layer was observed. In the hoses of Comparative Examples 4 and 5, the values of I₂×DBP of carbon black in their materials (acrylic rubber composition) were too large, and conductivity was high, with the result that rust occurred on the aluminum pipe (hose ferrule). In the hose of Comparative Example 6, the value of I₂×DBP of carbon black in its material (acrylic rubber composition) was small, and electric resistance was high, with the result that the generation of pockmarks on the inner peripheral surface of the hose was observed although rust did not occur on the aluminum pipe (hose ferrule).

The acrylic rubber composition for a heat-resistant hose is preferably used as a material for forming an innermost layer of an oil cooler hose for an automatic transmission (AT or CVT) for an automobile, a turbo air hose for an automobile, and the like. In addition, those heat-resistant hoses are preferably used for transport vehicles, such as automobiles, tractors, cultivators, and ships.

Although specific forms of embodiments of the present invention have been described above in order to be more clearly understood, the above description is made by way of example and not as a limitation to the scope of the present invention. It is contemplated that various modifications apparent to one of ordinary skill in the art could be made without departing from the scope of the invention.

What is claimed is:

1. An acrylic rubber composition for a heat-resistant hose, comprising the following components (A), (B) and (C):
(A) an ethylene-acrylic rubber (AEM);
(B) an acrylic rubber (ACM) excluding the component (A); and
(C) carbon black having a value of iodine adsorption amount (mg/g)×DBP absorption amount (cm³/100 g) of from 1,500 to 7,200,
Wherein a content ratio between the component (A) and the component (B), (A)/(B), is from 95/5 to 45/55 by weight.

2. An acrylic rubber composition for a heat-resistant hose according to claim 1, wherein a content of the component (C) is from 40 parts by weight to 90 parts by weight with respect to 100 parts by weight of a total content of the component (A) and the component (B).

3. An acrylic rubber composition for a heat-resistant hose according to claim 1, wherein the content ratio between the component (A) and the component (B), (A)/(B), is from 93/7 to 70/30.

4. An acrylic rubber composition for a heat-resistant hose according to claim 1, wherein the carbon black (C) has a value of iodine adsorption amount (mg/g)×DBP absorption amount (cm³/100 g) of from 1,700 to 4,000.

5. An acrylic rubber composition for a heat-resistant hose according to claim 1, wherein the carbon black (C) has an iodine adsorption amount of from 20 mg/g to 40 mg/g.

6. An acrylic rubber composition for a heat-resistant hose according to claim 1, wherein the carbon black (C) has an iodine adsorption amount of from 20 mg/g to 30 mg/g.

7. An acrylic rubber composition for a heat-resistant hose according to claim 1, wherein the carbon black (C) has a DBP absorption amount of from 60 cm³/100 g to 160 cm³/100 g.

8. An acrylic rubber composition for a heat-resistant hose according to claim 1, wherein the carbon black (C) has a DBP absorption amount of from 80 cm³/100 g to 130 cm³/100 g.

9. An acrylic rubber composition for a heat-resistant hose according to claim 1, wherein a content of the component (C) is from 50 parts by weight to 80 parts by weight with respect to 100 parts by weight of a total content of the component (A) and the component (B).

10. An acrylic rubber composition for a heat-resistant hose according to claim 1, further comprising at least one selected from the group consisting of a vulcanizing agent, a vulcanizing aid, a processing aid, a plasticizer, an age resistor, a flame retardant, and a co-crosslinking agent.

11. An acrylic rubber composition for a heat-resistant hose according to claim 1, further comprising an organic peroxide and a co-crosslinking agent.

12. A heat-resistant hose, comprising at least one structural layer, wherein the at least one structural layer comprises an innermost layer comprising the acrylic rubber composition of claim 1.

13. A heat-resistant hose according to claim 12, wherein the innermost layer has a thickness of from 0.25 mm to 20 mm.

14. A heat-resistant hose according to claim 12, wherein the innermost layer has a thickness of from 0.5 mm to 10 mm.

15. A heat-resistant hose according to claim 12, wherein the heat-resistant hose has an inner diameter of from 2 mm to 100 mm.

16. A heat-resistant hose according to claim 12, wherein the heat-resistant hose has an inner diameter of from 5 mm to 70 mm.
